(19) United States
(12) Patent Application Publication
(10) Pub. No.: US 2025/0203587 A1
(43) Pub. Date: Jun. 19, 2025

(54) USER EQUIPMENT AND METHOD FOR PROTECTING RESOURCES IN SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(73) Assignee: GUANGDONG OPPO MOBILE TELECOMMUNICATIONS CORP., LTD., Dongguan (CN)

(21) Appl. No.: 19/068,656

(22) Filed: Mar. 3, 2025

Related U.S. Application Data
(63) Continuation of application No. PCT/CN2022/129978, filed on Nov. 4, 2022.

(51) Int. Cl. H04W 72/0446; H04W 72/51; H04W 72/56; H04W 92/18

(52) U.S. Cl. CPC H04W 72/0446; H04W 72/51; H04W 72/56; H04W 92/18

(57) ABSTRACT

A method for protecting resources in sidelink communication (SL) by a user equipment (UE) includes performing, by the UE, a use of multi-consecutive slots transmission (MCSt) in a SL resource pool based on one or more of the followings: MCSt enabling/disabling based on a configuration, MCSt enabling/disabling based on a priority threshold, MCSt resource assignment/reservation based on increasing a MCSt priority level, re-evaluation and/or pre-emption checking enabling/disabling for MCSt based on the configuration, re-evaluation and/or pre-emption checking enabling/disabling for MCSt based on the priority threshold, re-evaluation and/or pre-emption checking based on time granularity, exclusion of a MCSt resource during a resource selection at another UE, and/or exclusion of the MCSt resource based on the configuration at the another UE.

### CROSS-REFERENCE TO RELATED APPLICATIONS

This application is a continuation of International Application No. PCT/CN2022/129978, filed on Nov. 4, 2022, the disclosure of which is hereby incorporated by reference in its entirety.

### BACKGROUND OF DISCLOSURE

### 1. Field of the Disclosure

The present disclosure relates to the field of communication systems, and more particularly, to a user equipment (UE) and a method for protecting resources in sidelink communication (SL), which can provide a good communication performance and/or provide high reliability.

### 2. Description of the Related Art

In the advancement of radio wireless transmission and reception directly between two devices, which is often known as device-to-device (D2D) communication, it was first developed by 3rd generation partnership project (3GPP) and introduced in release 12 (officially specified as sidelink communication) for public safety emergency usage such as mission critical communication to support mainly low data rate and voice type of connection. In 3GPP releases 14, 15, and 16, the sidelink technology was advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology was further enhanced in release 17 in the area of power saving and transceiver link reliability. For release 18, 3GPP is looking to evolve the wireless technology and expand its operation into unlicensed frequency spectrum for bigger bandwidth, faster data rate, and easier market adoption of D2D communication using sidelink without requiring mobile cellular operators to configure and allocate a part of their expansive mobile radio spectrum for data services that do not go throughput their mobile networks.

Therefore, there is a need for a user equipment (UE) and a method for protecting resources in sidelink communication (SL), which can solve issues in the prior art, avoid transmission collision, reduce the likelihood of a multi-consecutive slots transmission (MCSt) being interfered by other UEs and to avoid any impact to retaining an access to an unlicensed channel when a MCSt is disrupted from other UEs, provide a good communication performance, and/or provide high reliability.

### SUMMARY

In a first aspect of the present disclosure, a user equipment (UE) includes an executor configured to perform a use of multi-consecutive slots transmission (MCSt) in a SL resource pool based on one or more of the followings: MCSt enabling/disabling based on a configuration, MCSt enabling/disabling based on a priority threshold, MCSt resource assignment/reservation based on increasing a MCSt priority level, re-evaluation and/or pre-emption checking enabling/disabling for MCSt based on the configuration, re-evaluation and/or pre-emption checking enabling/disabling for MCSt based on the priority threshold, re-evaluation and/or pre-emption checking based on time granularity, exclusion of a MCSt resource during a resource selection at another UE, and/or exclusion of the MCSt resource based on the configuration at the another UE.

In a second aspect of the present disclosure, a method for protecting resources in sidelink communication (SL) by a user equipment (UE) includes performing, by the UE, a use of multi-consecutive slots transmission (MCSt) in a SL resource pool based on one or more of the followings: MCSt enabling/disabling based on a configuration, MCSt enabling/disabling based on a priority threshold, MCSt resource assignment/reservation based on increasing a MCSt priority level, re-evaluation and/or pre-emption checking enabling/disabling for MCSt based on the configuration, re-evaluation and/or pre-emption checking enabling/disabling for MCSt based on the priority threshold, re-evaluation and/or pre-emption checking based on time granularity, exclusion of a MCSt resource during a resource selection at another UE, and/or exclusion of the MCSt resource based on the configuration at the another UE.

In a third aspect of the present disclosure, a user equipment (UE) includes a memory, a transceiver, and a processor coupled to the memory and the transceiver. The UE is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method for protecting resources in sidelink communication (SL) by a UE according to an embodiment of the present disclosure.

FIG. 5 is a block diagram of a UE for wireless communication according to an embodiment of the present disclosure.

FIG. 6 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Unlicensed Spectrum

Traditionally, unlicensed (also referred as license-exempted) radio spectrum in 2.4 GHz and 5 GHz bands are commonly used by Wi-Fi and Bluetooth wireless technologies for short range communication (such as from just a few meters to few tens of meters). It is often claimed that more traffic is carried over unlicensed spectrum bands than any other radio bands since the frequency spectrum is free/at no-cost to use by anyone as long as communication devices are compliant to certain local technical regulations. Besides, Wi-Fi, Bluetooth, and other radio access technologies (RATs) such as licensed-assisted access (LAA) based on 4G-long term evolution (LTE) and new radio unlicensed (NR-U) based on 5G-new radio (NR) mobile systems from 3GPP also operate in the same unlicensed bands. In order for devices of different RATs (Wi-Fi, Bluetooth, LAA, NR-U and possibly others) to operate simultaneously and coexistence fairly in the same geographical area without causing significant interference and interruption to each other's transmission, a clear channel access (CCA) protocol such as listen-before-talk (LBT) adopted in LAA and NR-U and carrier sense multiple access/collision avoidance (CSMA/CA) used in Wi-Fi and Bluetooth are employed before any wireless transmission is carried out to ensure that a wireless radio does not transmit while another is already transmitting on the same channel.

For the sidelink wireless technology to also operate and coexistence with existing RATs already operating in the unlicensed bands, LBT based schemes can be employed to make certain there is no on-going activity on the radio channel before attempting to access the channel for transmission. For example, when a type 1 LBT is successfully performed by a sidelink user equipment (UE), the UE has the right to access and occupy the unlicensed channel for a duration of a channel occupancy time (COT). During an acquired COT, however, a device of another RAT could still gain access to the channel if no wireless transmission is performed by the COT initiation sidelink UE or a COT responding sidelink UE for an idle period longer than 25 us. Hence, potentially losing the access to the channel until another successful LBT is performed. A potential solution to this issue of losing the access to the channel could be a back-to-back (B2B) transmission.

### Back-to-Back transmission

The main purpose of B2B transmission (which can be also referred as “burst transmission” or “multi-consecutive slot transmission (MCSt)”) is intended for a sidelink (SL) communicating UE to occupy an unlicensed channel continuously for longer duration of time (i.e., more than one time slot) without a risk of losing the access to the channel to wireless transmission (Tx) devices of other radio access technologies (RATs). This can be particular important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or has a short latency requirement (small packet delay budget, PDB). When the unlicensed wireless channel is busy/congested (e.g., with many devices trying to access the channel simultaneously for transmission), it can be difficult and take up a long time to gain access to the channel due to the random backoff timer and priority class category in the LBT procedure. Therefore, when a UE finally has a chance/opportunity to gain access to the wireless channel for a channel occupancy time (COT) length which may last for a few milliseconds (e.g., 4, 8, or 10 ms), the intention is to retain the channel access for as long as possible (e.g., all or most of the COT length) to send as much data as possible by continuously transmitting in the unlicensed channel such that wireless devices of other RATs would not have a chance to access the channel.

### Re-Evaluation and Pre-Emption Checking

The design of the resource re-evaluation and pre-emption checking feature, which was developed and introduced in 3GPP Release 16 for NR sidelink resource allocation mode 2, is for the transmitter UE (Tx-UE) to verify the availability of pre-selected and reserved resources just a few slots (e.g., 1 to 2 ms) before the it carries out the actual SL transmission using these resources. If any of these pre-selected or reserved resources is found to be taken over by a higher priority transmission from another SL UE after the initial resource selection or since the last checking, the affected resource is reported to a higher layer (i.e., MAC layer) for re-selection. Then the higher layer re-selects/replaces the pre-empted resource from a new set of available resources that are not yet indicated/reserved by others. Therefore, the sole purpose of resource re-evaluation and pre-emption checking is to avoid any potential transmission collision just before the resource is being used (i.e., a last moment verification check).

For a B2B transmission, however, if found all or part of the B2B transmission resources are reserved/taken over by other higher priority transmissions during the resource re-evaluation and pre-emption checking process, it could have a significant impact to the sidelink communication performance for the Tx-UE and also other receiver UEs. For example:

When a set of SL resources across multiple consecutive slots are reserved by a Tx-UE for B2B transmission and one of the said set of resources is pre-empted/taken over by a higher priority transmission during a pre-emption checking, it may force the UE to perform re-selection for the pre-empted resource. But there is no guarantee that a new resource can be selected in the same pre-empted slot to retain the B2B transmission without a gap. If no available resource can be selected in the same slot, the Tx-UE may loss the access to the channel due to non-continuous transmission and occupation of the channel. In this case, the Tx-UE may not be able to complete its transmissions within a required time delay budget.

Subsequently, the responding receiver (Rx) UE may no longer able to utilize the COT shared by the Tx-UE for SL transmission when the access to the channel is lost. In the worst-case scenario, if the Rx-UE is not able to gain access to the unlicensed channel in time by performing a full Type 1 LBT, the Rx-UE may need to perform resource re-selection for its own SL transmissions.

Furthermore, if the original set of B2B resources are reserved by the Tx-UE for a single transmission of a medium access control (MAC) layer transport block (TB) or packet data unit (PDU), the Tx-UE may need to perform channel encoding of the entire TB with the remaining available/lesser resources, and thus, increase the coding rate and cause negative impact to the D2D communication link performance. In the worst case, if one of the pre-selected/reserved B2B resource is found to be pre-empted/taken over by another UE at a later slot timing after the transmission of the MAC PDU/TB has already begun, it is very likely the receiver UE may not decode the MAC PDU/TB successfully since a portion of the data is not transmitted due to resource pre-emption.

Hence, it is important that the B2B/multi-consecutive slots transmission resources can be protected to minimize the disruption to the normal operation of SL communication in an unlicensed radio channel.

In the present proposed exemplary methods for protecting multi-consecutive slots transmission (MCSt) in NR sidelink communication, the main objectives are to reduce the likelihood of a MCSt being interfered by other UEs and to avoid any impact to retaining the access to an unlicensed channel when a MCSt is disrupted from other UEs. These can be achieved by controlling pre-emption of a MCSt resource, raising the bar that a MCSt resource can be taken over by others and/or disabling the re-evaluation and pre-emption checking for MCSt resources.

Other benefits from protecting resources that are selected or reserved for MCSt in NR sidelink communication may include:

In a SL unicast communication, the protection helps to ensure adequate sidelink reference signal received power (SL-RSRP) and channel state information (CSI) are measured, calculated, and fed back by the receiver to the transmitter UE for the purpose of performing sidelink power control and improving the radio performance of the sidelink connection.

When MCSt resources are used for transmitting the same MAC PDU/TB, the protection may ensure that data content of the MAC PDU/TB is not interrupted, and hence, maintaining the ability to decode the data by the receiver UE.

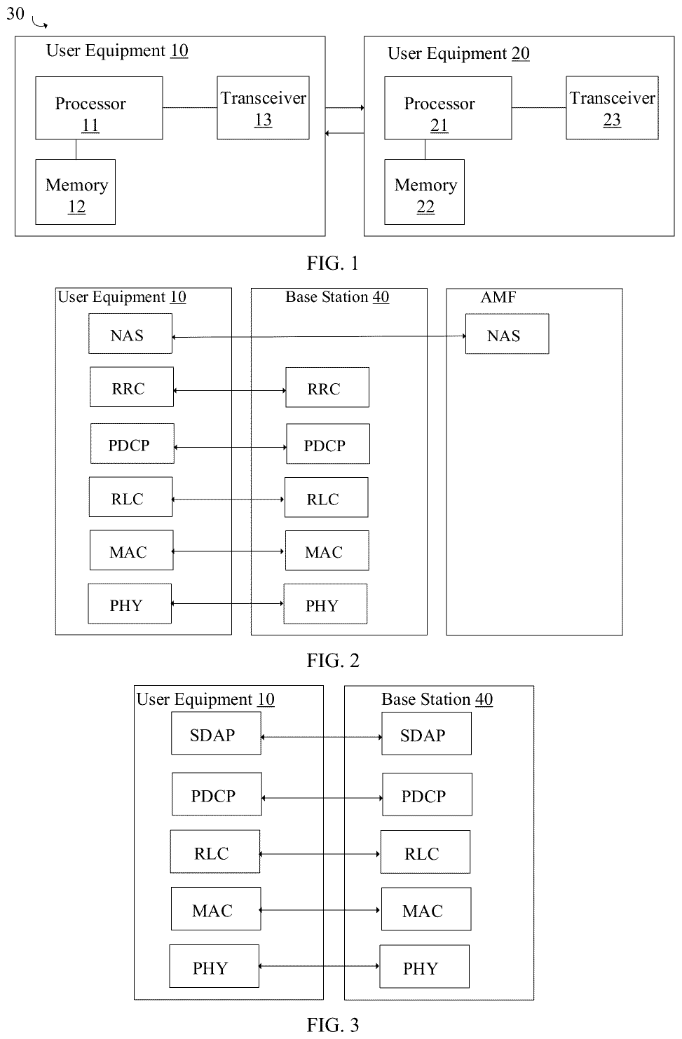

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR release 17 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 2 illustrates that, in some embodiments, in the control plane protocol stack where PDCP, RLC, and MAC sublayers and PHY layer may be terminated in a UE 10 and a base station 40 (such as gNB) on a network side and perform service and functions described above. In an example, RRC used to control a radio resource between the UE and a base station (such as a gNB). In an example, RRC may be terminated in a UE and the gNB on a network side. In an example, services and functions of RRC may comprise broadcast of system information related to AS and NAS, paging initiated by 5GC or RAN, establishment, maintenance and release of an RRC connection between the UE and RAN, security functions including key management, establishment, configuration, maintenance and release of signaling radio bearers (SRBs) and data radio bearers (DRBs), mobility functions, QOS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an AMF for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to perform a use of multi-consecutive slots transmission (MCSt) in a SL resource pool based on one or more of the followings: MCSt enabling/disabling based on a configuration, MCSt enabling/disabling based on a priority threshold, MCSt resource assignment/reservation based on increasing a MCSt priority level, re-evaluation and/or pre-emption checking enabling/disabling for MCSt based on the configuration, re-evaluation and/or pre-emption checking enabling/disabling for MCSt based on the priority threshold, re-evaluation and/or pre-emption checking based on time granularity, exclusion of a MCSt resource during a resource selection at another UE, and/or exclusion of the MCSt resource based on the configuration at the another UE. In some examples, the configuration can be understood as a network configuration or a pre-configuration. This can solve issues in the prior art, avoid transmission collision, reduce the likelihood of a multi-consecutive slots transmission (MCSt) being interfered by other UEs and to avoid any impact to retaining an access to an unlicensed channel when a MCSt is disrupted from other UEs, provide a good communication performance, and/or provide high reliability.

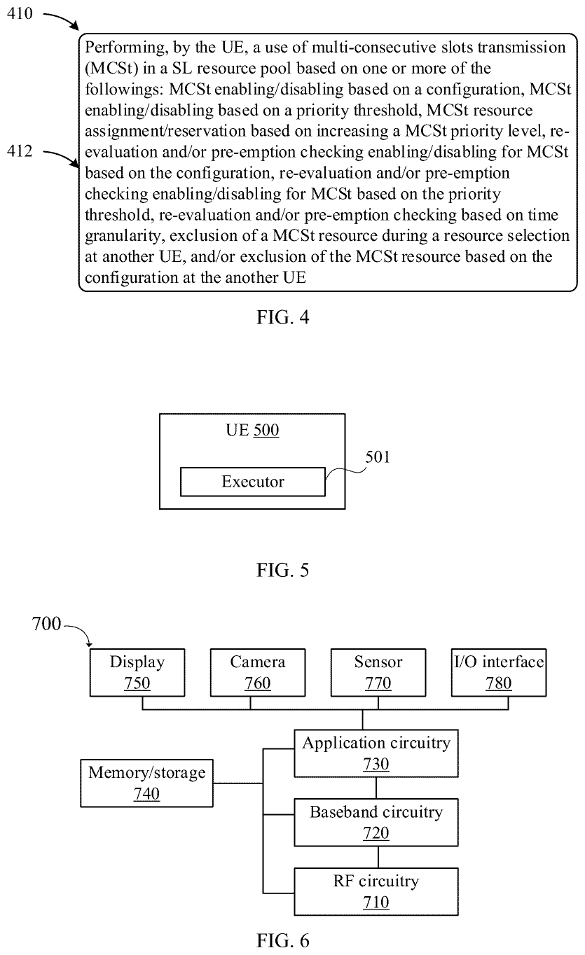

FIG. 4 illustrates a method for protecting resources in sidelink communication (SL) by a UE according to an embodiment of the present disclosure. In some embodiments, the method 410 includes: a block 412, performing, by the UE, a use of multi-consecutive slots transmission (MCSt) in a SL resource pool based on one or more of the followings: MCSt enabling/disabling based on a configuration, MCSt enabling/disabling based on a priority threshold, MCSt resource assignment/reservation based on increasing a MCSt priority level, re-evaluation and/or pre-emption checking enabling/disabling for MCSt based on the configuration, re-evaluation and/or pre-emption checking enabling/disabling for MCSt based on the priority threshold, re-evaluation and/or pre-emption checking based on time granularity, exclusion of a MCSt resource during a resource selection at another UE, and/or exclusion of the MCSt resource based on the configuration at the another UE. In some examples, the configuration can be understood as a network configuration or a pre-configuration. This can solve issues in the prior art, avoid transmission collision, reduce the likelihood of a multi-consecutive slots transmission (MCSt) being interfered by other UEs and to avoid any impact to retaining an access to an unlicensed channel when a MCSt is disrupted from other UEs, provide a good communication performance, and/or provide high reliability.

In some embodiments, in the MCSt enabling/disabling based on the configuration, when the configuration is set to enabled, the MCSt is allowed in the SL resource pool or the UE is allowed to selected resources in consecutive slots for SL transmissions. In some embodiments, in the MCSt enabling/disabling based on the priority threshold, the MCSt enabling/disabling is based on whether a SL transmission priority level is higher or lower than a priority threshold value. In some embodiments, the priority threshold value is configured or pre-defined. In some embodiments, the SL transmission priority level is a first layer (L1) priority for transmission, a priority field in sidelink control information (SCI), or a channel access priority class (CAPC) level.

In some embodiments, in the MCSt resource assignment/reservation based on increasing the MCSt priority level, a priority level of the MCSt priority is increased by a pre-defined or configured value, X. In some embodiments, when the priority level of the MCSt priority cannot be increased by X, a highest priority level of the MCSt priority is indicated. In some embodiments, in the MCSt resource assignment/reservation based on increasing the MCSt priority level, a maximum priority value is configured or pre-defined for MCSt in the SL resource pool. In some embodiments, when an original transmission priority value for MCSt for SL transmission is higher than the configured or pre-defined maximum priority value, a configured priority threshold value is indicated for a priority field in a SCI. In some embodiments, in the re-evaluation and/or pre-emption checking enabling/disabling for MCSt based on the configuration, when the configuration is set to disabled, the UE does not perform re-evaluation and/or pre-emption checking for MCSt, and/or when the configuration is set to enabled, the UE performs re-evaluation and/or pre-emption checking for MCSt.

In some embodiments, in the re-evaluation and/or pre-emption checking enabling/disabling for MCSt based on the priority threshold, reporting and re-selection/replacement of a MCSt resource at the UE is supported when a priority level in a received SCI for an indicated resource that overlaps with the MCSt resource is above a configured threshold for the SL resource pool. In some embodiments, in the re-evaluation and/or pre-emption checking based on the time granularity, the time granularity for the re-evaluation and/or pre-emption checking for MCSt is based on a per slot-set basis and one or more resources of a resource set provided for the re-evaluation and/or pre-emption checking is reported to a higher layer, an entire resource set is re-selected/replaced. In some embodiments, in the re-evaluation and/or pre-emption checking based on the time granularity, the time granularity for the re-evaluation and/or pre-emption checking for MCSt is based on a per slot basis and one of resources provided for the re-evaluation and/or pre-emption checking is no longer available, the UE continues a resource selection procedure in L1 until another resource in the same slot as a provided/no longer available resource is part of a remaining candidate resource set.

In some embodiments, in the exclusion of the MCSt resource during the resource selection at the another UE, during a SL mode 2 resource selection procedure, when an indication is provided in a received SCI informing assigned resources in the SCI are reserved for MCSt, the resources are not to be selected by the another UE. In some embodiments, the indication provided in the received SCI for MCSt includes a parameter field included as a part of the SCI, a SCI format that is designed or intended to indicate/reserve MCSt resources, or a radio network terminal identifier (RNTI) or cyclic redundancy check (CRC) scrambling pre-defined or configured for MCSt. In some embodiments, the exclusion of the MCSt resource during the resource selection at the another UE is based on at least one or a combination of two or more of several conditions including: a priority threshold level; a comparison in a priority level between a transmission priority and a priority indicated in a received SCI; and a difference in the priority level between the transmission priority and the priority indicated in the received SCI.

In some embodiments, in the exclusion of the MCSt resource based on the configuration at the another UE, the UE is allowed to select a resource or not to exclude a resource that overlaps with the MCSt resource from other UEs. In some embodiments, when disabled by a resource pool configuration, a resource or a set of resources indicated/reserved for MCSt in a received SCI is excluded during a resource selection procedure. In some embodiments, when a pre-emption of MCSt resources is enabled, the exclusion of the MCSt resource during the resource selection at the another UE is based on at least one or a combination of two or more of several conditions including: a priority threshold level; a comparison in a priority level between a transmission priority and a priority indicated in a received SCI; and a difference in the priority level between the transmission priority and the priority indicated in the received SCI.

In the above embodiments, the term “configured” can also refer to the term “pre-configured” or “network configured”. In the above embodiments, the term “configuration” can also refer to the term “pre-configuration” or “network configuration”.

FIG. 5 illustrates a UE 500 for wireless communication according to an embodiment of the present disclosure. The UE 500 includes an executor 501 configured to perform a use of multi-consecutive slots transmission (MCSt) in a SL resource pool based on one or more of the followings: MCSt enabling/disabling based on a configuration, MCSt enabling/disabling based on a priority threshold, MCSt resource assignment/reservation based on increasing a MCSt priority level, re-evaluation and/or pre-emption checking enabling/disabling for MCSt based on the configuration, re-evaluation and/or pre-emption checking enabling/disabling for MCSt based on the priority threshold, re-evaluation and/or pre-emption checking based on time granularity, exclusion of a MCSt resource during a resource selection at another UE, and/or exclusion of the MCSt resource based on the configuration at the another UE. In some examples, the configuration can be understood as a network configuration or a pre-configuration. This can solve issues in the prior art, avoid transmission collision, reduce the likelihood of a multi-consecutive slots transmission (MCSt) being interfered by other UEs and to avoid any impact to retaining an access to an unlicensed channel when a MCSt is disrupted from other UEs, provide a good communication performance, and/or provide high reliability.

In the present disclosure of proposed exemplary methods for protecting pre-selected and/or reserved resources for multi-consecutive slots transmission (MCSt) from being taken over/pre-empted by another user equipment (UE) in sidelink (SL) communication, the methods provide efficient ways of retaining the access to the unlicensed channel and ensuring SL data information is transmitted without delay and received by others without interruption.

In the present disclosure of proposed exemplary methods for protecting pre-selected and/or reserved resources for multi-consecutive slots transmission (MCSt) from being taken over/pre-empted by another user equipment (UE) in sidelink (SL) communication, the methods provide efficient ways of retaining the access to the unlicensed channel and ensuring SL data information is transmitted without delay and received by others without interruption.

In order to protect SL transmitter UE (Tx UE) MCSt resources from being taken over/pre-empted by other UEs operating in the same SL transmission resource pool, there can be several different mechanisms to prevent or reduce/minimize the chance/likelihood of such pre-emption from being carried out. Or even in the case when one or more MCSt resources are taken over/pre-empted by others, there are ways to reduce/minimize the impact to the overall operation of SL and MCSt transmission.

The use of the methods described in the present exemplary disclosure are not meant to be exclusive. That is, when it is practically feasible, it should be possible to jointly use more than one of the proposed exemplary methods described in this invention.

Category A, MCSt is restricted or enhanced at the transmitter side to protect its own transmission (MCSt protection by the Tx-UE)

Exemplary Method 1 (MCSt enabling/disabling based on priority threshold): For a given sidelink resource pool (e.g., a “mode 2” /“selected” resource pool), the use of MCSt may be enabled/disabled by (pre-)configuration. When MCSt is enabled by (pre-)configuration, a sidelink transmitter UE (Tx-UE) performs a resource (re)selection function or procedure that ensures SL resources are (re-)selected for transmission in consecutive slots (e.g., more than one slot) within a resource pool. The consecutive slots may be (re-)selected within a known COT duration and position (e.g., a COT shared by another UE or self-initiated COT), or within an anticipated COT duration and position (e.g., a COT to be initiated by the Tx-UE itself). To implement this mechanism, as an example, an RRC parameter sl-MCStEnable could be (pre-)configured for enabling MCSt in a sidelink resource pool. When sl-MCStEnable is provided, or provided and set to “enabled”, this allows MCSt to be used in the resource pool.

Alternatively, the use of MCSt may be enabled/allowed/supported in a resource pool only for a sidelink transmission priority level (e.g.,) that is equal to or less than a priority threshold value that is (pre-)configured or pre-defined. The sidelink transmission priority level could be a L1 priority (prio_{TX}), the priority field in sidelink control information (SCI) or the channel access priority class (CAPC) level (p). Otherwise, the use of MCSt is disabled/not allowed in the resource pool. By restricting the use of MCSt only for sidelink data packets with higher priorities, it is less likely the pre-selected/reserved sidelink resources can be pre-empted/taken over by even higher priority transmissions. Thus, the less chance/smaller probability that the Tx-UE may need to perform resource re-selection and resulting with a gap in a MCSt for devices of other RATs to gain access to the unlicensed channel. To implement this mechanism, as an example, an RRC parameter sl-MCStEnable could be (pre-)configured with its value set to one of 8 priority levels (e.g., from 1 to 8), this means that MCSt is enabled in the resource pool and a priority threshold (prio_{MCSt_TH}) is configured with the set value. When sl-MCStEnable is provided with its set value to one of 8 or 4 priority levels and prio_{MCSt_TH}≥prio_{TX}, priority in SCI or CAPC (p), then MCSt is allowed for the sidelink transmission. If the priority level is associated with prio_{TX} or priority in SCI, the priority threshold (prio_{MCSt_TH}) would have 8 levels. If the priority level is associated with CAPC (p), the priority threshold (prio_{MCSt_TH}) would have 4 levels.

Note that:

A smaller prio_{TX} and CAPC (p) value means higher priority for transmission.

(Pre-)configuration in the present disclosure of invention generally refers to configuration by a radio resource control (RRC) protocol.

Pre-defined value or rule may refer to what is defined in the protocol, which could be standard protocol(s) in the communication field.

Exemplary Method 2 (increasing MCSt priority): When the use of MCSt is enabled/supported (e.g., by (pre-)configuration or pre-defined based on UE capability) and/or a UE performs MCSt in a resource pool, a higher level of transmission priority (i.e., with a lower priority value) may be indicated in the associated SCI to reduce/minimize/prevent the indicated resources for MCSt from being pre-empted/taken over by other UE with an even higher priority. Once other UEs detect that a higher priority is indicated in a Tx-UE's SCI, it is less likely/harder for other UEs to pre-empt/take over the reserved resource from the Tx-UE. There may be different ways to implement this objective.

Exemplary Method 2.1: Increase the priority level (i.e., a lower value for the priority field in SCI) by a pre-defined or (pre-)configured value. For example, always increase the priority level (i.e., a lower value for the priority field in SCI) by a pre-defined or (pre-)configured value, X, whenever MCSt is used. Assuming the original transmission priority for MCSt is Y, then the priority value to be indicated in SCI would be Z=Y−X. When another UE receives the transmitted SCI, it may use the indicated priority level Z as a L1 priority (prio_{RX}) during sensing and resource allocation purposes and determine the original transmission priority for MCSt as Y=Z+X, since the value of X is common to all UEs based on pre-definition or (pre-)configuration. In the case when Y−X<1, the priority value to be indicated in SCI (Z) should be 1, which is the lowest priority value that can be indicated in SCI.

Exemplary Method 2.2: A minimum priority is firstly (pre-)configured or pre-defined for MCSt in a resource pool (prio_{min_MCSt}); When the original transmission priority value for MCSt (e.g., a L1 priority prio_{TX}) for a sidelink transmission of a MAC PDU or TB is higher than the (pre-)configured minimum priority value (meaning the original priority level is lower than a minimum level), the (pre-)configured priority threshold value is indicated for the priority field in SCI. That is, when the L1 priority value (prio_{TX}) for a MCSt is higher than prio_{min_MCSt}, then prio_{min_MCSt} is to be indicated for the priority field in SCI. Otherwise, the original prio_{TX} value should be indicated for the priority field in SCI. As an example, assuming the L1 priority (prio_{TX}) for a MCSt is 8 and the (pre-)configured prio_{min_MCSt} is 4, then a value 4 should be indicated for the priority field in SCI.

Additionally, for both exemplary Method 2.1 and 2.2, a new 1-bit parameter field (MCSt) may be included in SCI indicating the associated sidelink transmission is for MCSt. Hence, implying at least the indicated priority value in SCI is adjusted accordingly. Alternatively, a different SCI format could be pre-defined, or a different radio network temporary identifier (RNTI) or cyclic redundancy check (CRC) scrambling could be used for indicating a MCSt and/or reserving a resource for MCSt.

Exemplary Method 3 (re-evaluation and pre-emption enabling/disabling for MCSt based on priority threshold): Another way to protect Tx-UE pre-selected/reserved resources for MCSt from being taking over or pre-empted by others, besides increasing the priority level in the transmitted SCI according to exemplary Method 2, is to not give up the already pre-selected/reserved MCSt resources by enabling/disabling the re-evaluation and pre-emption checking function for MCSt altogether. As explained previously, the main purpose of resource re-evaluation and pre-emption checking is to verify the availability of pre-selected and/or reserved resources just before the actual transmission. When the resource re-evaluation and pre-emption checking for MCSt is “disabled”, the Tx-UE does not need to carry out the resource availability checking just before the transmission. When it is “enabled”, the resource availability checking is carried out by the Tx-UE. If a MCSt resource is no longer available based resource reservation in a received SCI (e.g., taken over/pre-empted by another UE with higher priority level prio_{RX}), the UE reports re-evaluation or pre-emption to its higher layer for resource re-selection/replacement of the reported resource. To implement this mechanism, as an example, an RRC parameter sl-ReevaluationPreemptionMCStEnable could be (pre-)configured in a resource pool for enabling re-evaluation and pre-emption checking function for MCSt. When at least one of sl-ReevaluationPreemptionMCStEnable is provided and set to “enabled”, and the priority value of the Tx-UE for MCSt (prio_{TX}) is larger than the priority value of a received sidelink transmission (prio_{RX}), prio_{TX}>prio_{RX}, then the pre-emption/re-evaluation resource is reported to the higher layer for re-selection/replacement.

Alternatively, a more stringent criterion can be included such that the reporting and re-selection/replacement of a MCSt resource at the Tx-UE is supported only when the priority level in a received SCI over-taking/pre-empting the MCSt resources is above a certain threshold (pre-)configured for the resource pool. To implement this mechanism, as an example, when the value of sl-ReevaluationPreemptionMCStEnable is set to one of 8 priority levels (1 . . . 8), it means re-evaluation and pre-emption checking for MCSt in the resource pool is enabled and a priority threshold value (prio_{pre-MCSt}) is configured. Then, when at least one of sl-ReevaluationPreemptionMCStEnable is provided and set to a priority level (i.e., not ‘enabled’), prio_{pre-MCSt}>prio_{RX}, and prio_{TX}>prio_{RX}, the pre-emption/re-evaluation resource is reported to the higher layer for re-selection/replacement.

Exemplary Method 4 (time granularity for re-evaluation/pre-emption checking): One more way to protect or minimize the interruption and impact to MCSt operation in the event of a MCSt resource is taken over/pre-empted by another UE is to re-select the entire resources for MCSt, so that there is no risk of a transmission gap within the MCSt and resulting in losing the access to the channel. According to the existing procedure defined in 3GPP Release 16, when a resource re-evaluation and/or pre-emption checking is triggered by a UE higher layer, the UE is provided with a set of single-slot based rᵢ and/or r′ᵢ resources, respectively. When one of the provided resources from the rᵢ and/or r′ᵢ set is no longer part of the candidate resources during the re-evaluation and pre-emption checking, the affected single-slot based resource is reported to the higher layer for re-selection/replacement. But there is no guarantee a different resource in the same slot (as the affected resource) is always available for the re-selection/replacement such that there is no transmission gap to retain the channel access. Hence, for the case of MCSt, when a resource from the rᵢ and/or r′ᵢ set is no longer available (i.e., taken over or pre-empted due to a received SCI from another UE), it is proposed one of the following options should be adopted.

Exemplary Option 1: For a given sidelink resource pool, the time-domain granularity for re-evaluating and/or pre-emption checking for MCSt is pre-defined, (pre-)configured or indicated by the higher layer to be per slot-set basis. That is, when a rᵢ and/or r′ᵢ set is provided by a higher layer for re-evaluation and/or pre-emption checking for MCSt, each of the provided rᵢ and/or r′represents a set of resources for MCSt (i.e., a set of multi-consecutive slots pre-selected/reserved resources for MCSt). Therefore, when one of the resources in the rᵢ and/or r′ᵢ set or the entire rᵢ and/or r′ᵢ set is reported to the higher layer, the entire set of resources in the rᵢ and/or r′ᵢ set for MCSt is re-selected/replaced.

Exemplary Option 2: Alternatively, when the time-domain granularity for re-evaluating and/or pre-emption checking for MCSt is pre-defined, (pre-)configured or indicated by the higher layer to be per slot basis and one of the resources in the provided rᵢ and/or r′ᵢ set is no longer available (i.e., not as part of the remaining candidate resource set S_{A} after a resource exclusion process), the UE Layer 1/PHY layer continue the resource (re)selection procedure (e.g., by incrementing the RSRP threshold in the resource exclusion process) until another resource in the same slot as the affected resource is part of the remaining candidate resource set S_{A}. As such, the said another resource could be used to replace the affected resource by the higher layer. It is possible that initially one of the resources in the provided rᵢ and/or r′ᵢ set is no longer available (i.e., taken over/pre-empted in a received SCI from other UE), L1/PHY layer tries to find another resource in the same slot that could be used as a replacement, and found the said another resource is the same as the affected resource that was taken over/pre-empted, then the UE L1/PHY layer does not report the affected resource to the higher layer for re-evaluation and pre-emption.

Category B, MCSt is protected during resource (re)selection procedure at another UE (MCSt protection by other UEs)

In Category A, various methods that could be employed by the Tx-UE for protecting or retaining its own MCSt from being taken-over/pre-empted by another UE operating in the same resource pool are proposed and described. Let's denote this MCSt UE is a UE_A. In addition to methods described in category A, when another UE (denote as UE_B) is performing a resource (re)selection procedure, which includes a resource sensing procedure that is required to receive SCI transmitted by other sidelink UEs in the same resource pool, a certain action(s) or method(s) could be also adopted by the UE_B to avoid collision or conflict with UE_A's MCSt. Hence a UE_A's MCSt is protected during the resource (re)selection procedure at the another UE (UE_B).

Exemplary Method 5: During a sidelink Mode 2 resource (re)selection procedure, when an indication is provided in a received SCI (e.g., from UE_A) representing or informing the assigned resources in the SCI are reserved for MCSt, these resources are not to be selected by the UE (i.e., UE_B). That is, the UE_B shall exclude the assigned/reserved MCSt resources from its candidate resource set for selection at the higher layer.

In some embodiments, the indication provided in a SCI for MCSt could be a parameter field included as part of the SCI, a SCI format that is designed or intended to indicate/reserve MCSt resources (e.g., a dedicated SCI format for MCSt), or a RNTI or CRC scrambling pre-defined or (pre-)configured for MCSt.

Alternatively, instead of a hard exclusion of resource reserved for MCSt during a sidelink Mode 2 resource (re)selection procedure, the exclusion of a MCSt resource (e.g., at UE_B) could be based on at least one or a combination of two or more of several conditions including: a priority threshold level (prio_{MCSt_excludeTH}), a comparison in priority level between prio_{TX} and prio_{RX_MCSt}, and a difference in priority level between prio_{TX} and prio_{RX_MCSt}, where the priority threshold level (prio_{MCSt_excludeTH}) may be pre-defined, (pre-)configured or provided by the UE higher layer. prio_{TX} is a priority level provided by higher layer when triggering a sidelink Mode 2 resource (re)selection procedure for physical sidelink shared channel (PSSCH)/physical sidelink control channel (PSCCH) transmission (e.g., at UE_B). prio_{RX_MCSt} is a priority level indicated in a received SCI (e.g., from UE_A) for indicating/reserving a MCSt transmission/resource during sensing as part of the sidelink Mode 2 resource (re)selection procedure. For example, when a priority threshold level (prio_{MCSt_excludeTH}) is used, a MCSt resource should be excluded if prio_{RX_MCSt}≤prio_{MCSt_excludeTH} and/or prio_{TX}≥prio_{MCSt_excludeTH}. This means as long as the priority level of an indicated/reserved MCSt resource is higher than the priority threshold level, the MCSt resource should be excluded from the candidate resource set for selection. Or as long as the priority level of UE_B's sidelink transmission is below or equal to the priority threshold level, an indicated/reserved MCSt resource in a received SCI during sensing should be automatically excluded from the candidate resource set for selection. By setting the priority threshold value (prio_{MCSt_excludeTH}) to 1, it means taking over/pre-empting a MCSt resource is not possible during the resource (re)selection procedure. Note that again, a smaller priority value means a higher priority level.

As another example, a MCSt resource should be excluded if prio_{TX} value is larger than or equal to the value of prio_{RX_MCSt}. This means when the PSSCH/PSCCH transmission priority level is lower than the priority level of a MCSt resource indicated/reserved in a received SCI, the MCSt resource should be excluded from the candidate resource set for selection.

Yet another example, a MCSt resource should be excluded if the difference in priority level between prio_{TX} and prio_{RX_MCSt} is larger or equal to X, where X is pre-defined, (pre-)configured or provided by the higher layer in the UE. E.g., prio_{TX}−prio_{RX_MCSt} is larger or equal to X, and X is an integer value and it can be a negative value.

Exemplary Method 6: Simply an enabling/disabling by (pre-)configuration to take-over or pre-empt a MCSt resource. For example, when disabled by resource pool (pre-)configuration, a resource or a set of resources indicated/reserved for MCSt in SCI (e.g., from UE_A) should be excluded during the resource (re)selection procedure (e.g., at UE_B). When pre-emption of MCSt resources is enabled, the use of this method could be in conjunction with the conditions described in the above Exemplary Method 5.

And similar to the Exemplary Method 5 described in the above, the indication provided in a SCI for MCSt could be a parameter field included as part of the SCI, a SCI format that is designed or intended to indicate/reserve MCSt resources (e.g., a dedicated SCI format for MCSt), or a RNTI or CRC scrambling pre-defined or (pre-)configured for MCSt.

Commercial interests for some embodiments are as follows. 1. Solving issues in the prior art. 2. Avoiding transmission collision. 3. Reducing the likelihood of a multi-consecutive slots transmission (MCSt) being interfered by other UEs and to avoid any impact to retaining an access to an unlicensed channel when a MCSt is disrupted from other UEs. 4. Providing good communication performance. 5. Providing high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIOT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, and beyond for providing direct device-to-device (D2D) wireless communication services.

FIG. 6 is a block diagram of an example system 700 for wireless communication according to an embodiment of the present disclosure. Embodiments described herein may be implemented into the system using any suitably configured hardware and/or software. FIG. 6 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method for protecting resources in sidelink communication (SL) by a user equipment (UE), comprising:
performing, by the UE, a use of multi-consecutive slots transmission (MCSt) in a SL resource pool based on one or more of the followings:
MCSt enabling/disabling based on a configuration;
MCSt enabling/disabling based on a priority threshold;
MCSt resource assignment/reservation based on increasing a MCSt priority level;
re-evaluation and/or pre-emption checking enabling/disabling for MCSt based on the configuration;
re-evaluation and/or pre-emption checking enabling/disabling for MCSt based on the priority threshold;
re-evaluation and/or pre-emption checking based on time granularity;
exclusion of a MCSt resource during a resource selection at another UE; and/or
exclusion of the MCSt resource based on the configuration at the another UE.

2. The method of claim 1, wherein in the MCSt enabling/disabling based on the configuration, when the configuration is set to enabled, the MCSt is allowed in the SL resource pool or the UE is allowed to selected resources in consecutive slots for SL transmissions.

3. The method of claim 1, wherein in the MCSt enabling/disabling based on the priority threshold, the MCSt enabling/disabling is based on whether a SL transmission priority level is higher or lower than a priority threshold value.

4. The method of claim 3, wherein the priority threshold value is configured or pre-defined.

5. The method of claim 3, wherein the SL transmission priority level is a first layer (L1) priority for transmission, a priority field in sidelink control information (SCI), or a channel access priority class (CAPC) level.

6. The method of claim 1, wherein in the MCSt resource assignment/reservation based on increasing the MCSt priority level, a priority level of the MCSt priority is increased by a pre-defined or configured value, X.

7. The method of claim 6, wherein when the priority level of the MCSt priority cannot be increased by X, a highest priority level of the MCSt priority is indicated.

8. The method of claim 1, wherein in the MCSt resource assignment/reservation based on increasing the MCSt priority level, a maximum priority value is configured or pre-defined for MCSt in the SL resource pool.

9. The method of claim 8, wherein when an original transmission priority value for MCSt for SL transmission is higher than the configured or pre-defined maximum priority value, a configured priority threshold value is indicated for a priority field in a SCI.

10. The method of claim 1, wherein in the re-evaluation and/or pre-emption checking enabling/disabling for MCSt based on the configuration, when the configuration is set to disabled, the UE does not perform re- evaluation and/or pre-emption checking for MCSt, and/or when the configuration is set to enabled, the UE performs re-evaluation and/or pre-emption checking for MCSt.

11. The method of claim 1, wherein in the re-evaluation and/or pre-emption checking enabling/disabling for MCSt based on the priority threshold, reporting and re-selection/replacement of a MCSt resource at the UE is supported when a priority level in a received SCI for an indicated resource that overlaps with the MCSt resource is above a configured threshold for the SL resource pool.

12. The method of claim 1, wherein in the re-evaluation and/or pre-emption checking based on the time granularity, the time granularity for the re-evaluation and/or pre-emption checking for MCSt is based on a per slot-set basis and one or more resources of a resource set provided for the re-evaluation and/or pre-emption checking is reported to a higher layer, an entire resource set is re-selected/replaced.

13. The method of claim 1, wherein in the re-evaluation and/or pre-emption checking based on the time granularity, the time granularity for the re-evaluation and/or pre-emption checking for MCSt is based on a per slot basis and one of resources provided for the re-evaluation and/or pre-emption checking is no longer available, the UE continues a resource selection procedure in L1 until another resource in the same slot as a provided/no longer available resource is part of a remaining candidate resource set.

14. The method of claim 1, wherein in the exclusion of the MCSt resource during the resource selection at the another UE, during a SL mode 2 resource selection procedure, when an indication is provided in a received SCI informing assigned resources in the SCI are reserved for MCSt, the resources are not to be selected by the another UE.

15. The method of claim 14, wherein the indication provided in the received SCI for MCSt comprises a parameter field included as a part of the SCI, a SCI format that is designed or intended to indicate/reserve MCSt resources, or a radio network terminal identifier (RNTI) or cyclic redundancy check (CRC) scrambling pre-defined or configured for MCSt.

16. The method of claim 1, wherein the exclusion of the MCSt resource during the resource selection at the another UE is based on at least one or a combination of two or more of several conditions comprising:
a priority threshold level;
a comparison in a priority level between a transmission priority and a priority indicated in a received SCI; and
a difference in the priority level between the transmission priority and the priority indicated in the received SCI.

17. The method of claim 1, wherein in the exclusion of the MCSt resource based on the configuration at the another UE, the UE is allowed to select a resource or not to exclude a resource that overlaps with the MCSt resource from other UEs.

18. The method of claim 17, wherein when disabled by a resource pool configuration, a resource or a set of resources indicated/reserved for MCSt in a received SCI is excluded during a resource selection procedure.

19. The method of claim 17, wherein when a pre-emption of MCSt resources is enabled, the exclusion of the MCSt resource during the resource selection at the another UE is based on at least one or a combination of two or more of several conditions comprising:
a priority threshold level;
a comparison in a priority level between a transmission priority and a priority indicated in a received SCI; and
a difference in the priority level between the transmission priority and the priority indicated in the received SCI.

20. A user equipment (UE), comprising: a memory and a processor, wherein the memory is configured to store a computer program, and the processor is configured to execute the computer program stored in the memory to cause the user equipment to perform a use of multi-consecutive slots transmission (MCSt) in a SL resource pool based on one or more of the followings:
MCSt enabling/disabling based on a configuration;
MCSt enabling/disabling based on a priority threshold;
MCSt resource assignment/reservation based on increasing a MCSt priority level;
re-evaluation and/or pre-emption checking enabling/disabling for MCSt based on the configuration;
re-evaluation and/or pre-emption checking enabling/disabling for MCSt based on the priority threshold;
re-evaluation and/or pre-emption checking based on time granularity;
exclusion of a MCSt resource during a resource selection at another UE; and/or
exclusion of the MCSt resource based on theconfiguration at the another UE.
